(19) United States
(12) Patent Application Publication
(10) Pub. No.: US 2019/0351872 A1
(43) Pub. Date: Nov. 21, 2019

(54) ENHANCED VEHICLE DOOR LOCK

(71) Applicant: Ford Global Technologies, LLC, Dearborn, MI (US)

(72) Inventors: Anthony Mark PHILLIPS, Northville, MI (US); Yifan CHEN, Ann Arbor, MI (US); John Robert VAN WIEMEERSCH, Novi, MI (US)

(21) Appl. No.: 16/482,749

(22) PCT Filed: Feb. 1, 2017
(86) PCT No.: PCT/US2017/015962

§ 371 Date: Aug. 1, 2019

(51) Int. Cl. B60R 25/24; G06F 1/16; E05B 81/54; B60R 25/01

(52) U.S. Cl. CPC B60R 25/24; G06F 1/163; G08B 6/00; B60R 25/01; E05Y 2900/531; E05B 81/54

(57) ABSTRACT

A prompt is presented on a display of a wearable device upon detecting an event indicating a user leaving a vehicle. An input responding to the prompt is received. A vehicle door lock is instructed to move to a locked position upon receipt of the input.

### BACKGROUND

Vehicles typically have door locks for vehicle doors. The door locks prevent persons outside the vehicle from unauthorized movement of latches that secure the vehicle doors to a vehicle frame, preventing unauthorized access to the vehicle. The door locks can be actuated remotely, e.g., with a fob. A user of the vehicle can actuate the fob to lock the doors, e.g., by depressing a dedicated button on the fob.

### BRIEF DESCRIPTION OF THE DRAWINGS

FIG. 1 is a block diagram of an example system for locking a vehicle.

FIG. 2 is an example vehicle including a door lock.

FIG. 3 is an example wearable device for locking the vehicle.

FIG. 4 is a block diagram of an example process for locking the vehicle with the wearable device.

### DETAILED DESCRIPTION

A wearable computing device can detect an event indicating a user leaving a vehicle and present a prompt on a display of the wearable device. The wearable computing device can receive an input from the prompt. The wearable computing device can message a vehicle door lock controller in the vehicle to move the lock to a locked position upon receipt of the input.

By using the wearable device to lock the vehicle, the user can lock the vehicle without actuating the fob or contacting the vehicle door. Furthermore, by allowing the user to lock the vehicle with input to the wearable device, the user may be less likely to leave the area around the vehicle without locking the vehicle. Because the wearable device is typically present and available for the user to operate (as opposed to, e.g., a key fob that is in a pocket or a purse), the user can conveniently lock the vehicle.

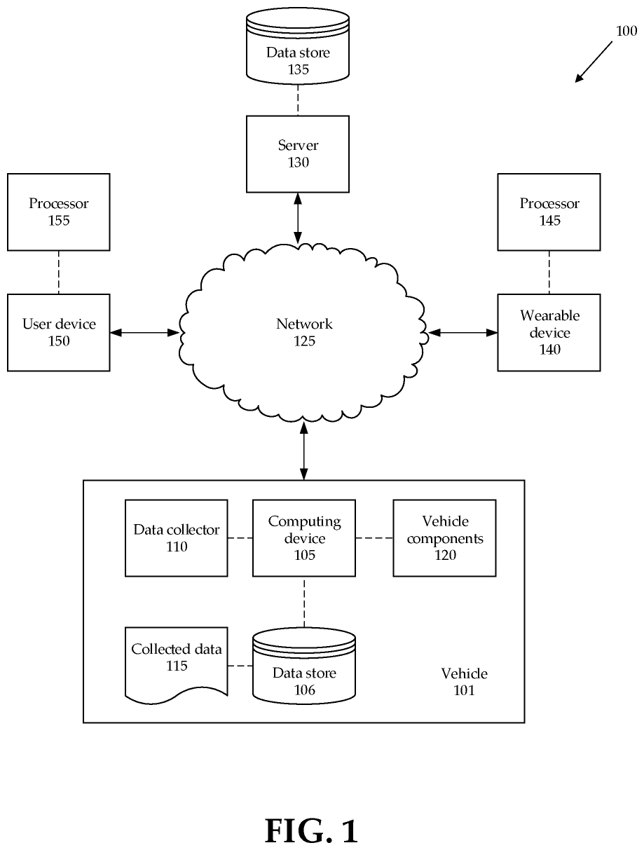

FIG. 1 illustrates a system 100 including a wearable device 140 communicatively coupled to a vehicle 101 computing device 105. The computing device 105 is programmed to receive collected data 115 from one or more sensors 110, e.g., vehicle 101 sensors, concerning various metrics related to the vehicle 101. For example, the metrics may include a velocity of the vehicle 101, vehicle 101 acceleration and/or deceleration, data related to vehicle 101 path or steering including lateral acceleration, curvature of the road, biometric data related to a vehicle 101 operator, e.g., heart rate, respiration, pupil dilation, body temperature, state of consciousness, etc. Further examples of such metrics may include measurements of vehicle systems and components (e.g. a steering system, a powertrain system, a brake system, internal sensing, external sensing, etc.). The computing device 105 may be programmed to collect data 115 from the vehicle 101 in which it is installed, sometimes referred to as a host vehicle 101, and/or may be programmed to collect data 115 about a second vehicle 101, e.g., a target vehicle.

The computing device 105 is generally programmed for communications on a controller area network (CAN) bus or the like. The computing device 105 may also have a connection to an onboard diagnostics connector (OBD II). Via the CAN bus, OBD II, and/or other wired or wireless mechanisms, the computing device 105 may transmit messages to various devices in a vehicle and/or receive messages from the various devices, e.g., controllers, actuators, sensors, etc., including sensors 110. Alternatively or additionally, in cases where the computing device 105 actually comprises multiple devices, the CAN bus or the like may be used for communications between devices represented as the computing device 105 in this disclosure. In addition, the computing device 105 may be programmed for communicating with the network 125, which, as described below, may include various wired and/or wireless networking technologies, e.g., cellular, Bluetooth®, wired and/or wireless packet networks, etc.

The data store 106 may be of any known type, e.g., hard disk drives, solid state drives, servers, or any volatile or non-volatile media. The data store 106 may store the collected data 115 sent from the sensors 110.

Sensors 110 may include a variety of devices. For example, various controllers in a vehicle may operate as sensors 110 to provide data 115 via the CAN bus, e.g., data 115 relating to vehicle speed, acceleration, system and/or component functionality, etc., of any number of vehicles 101, including the host vehicle and/or the target vehicle. Further, sensors or the like, global positioning system (GPS) equipment, etc., could be included in a vehicle and configured as sensors 110 to provide data directly to the computer 105, e.g., via a wired or wireless connection. Sensor sensors 110 could include mechanisms such as RADAR, LIDAR, sonar, etc. sensors that could be deployed to measure a distance between the vehicle 101 and other vehicles or objects. Yet other sensors 110 could include GPS devices, cameras, breathalyzers, motion detectors, etc., i.e., sensors 110 to provide data 115 for evaluating a condition or state of a vehicle 101 operator.

Collected data 115 may include a variety of data collected in a vehicle 101. Examples of collected data 115 are provided above, and moreover, data 115 is generally collected using one or more sensors 110, and may additionally include data calculated therefrom in the computer 105, and/or at the server 130. In general, collected data 115 may include any data that may be gathered by the sensors 110 and/or computed from such data.

The vehicle 101 may include a plurality of vehicle components 120. As used herein, each vehicle component 120 includes one or more hardware components adapted to perform a mechanical function or operation—such as moving the vehicle, slowing or stopping the vehicle, steering the vehicle, etc. Non-limiting examples of components 120 include a propulsion component (that includes, e.g., an internal combustion engine and/or an electric motor, etc.), a transmission component, a steering component (e.g., that may include one or more of a steering wheel, a steering rack, etc.), a brake component, a park assist component, an adaptive cruise control component, an adaptive steering component, and the like.

The system 100 may further include a network 125 connected to a server 130 and a data store 135. The computing device 105 may further be programmed to communicate with one or more remote sites such as the server 130, via a network 125, such remote site possibly including a data store 135. The network 125 represents one or more mechanisms by which a vehicle computer 105 may communicate with a remote server 130. Accordingly, the network 125 may be one or more of various wired or wireless communication mechanisms, including any desired combination of wired (e.g., cable and fiber) and/or wireless (e.g., cellular, wireless, WiFi, satellite, microwave, and radio frequency) communication mechanisms and any desired network topology (or topologies when multiple communication mechanisms are utilized). Exemplary communication networks include wireless communication networks (e.g., using Bluetooth®, BLE (Bluetooth® Low Energy), IEEE 802.11, etc.), local area networks (LAN) and/or wide area networks (WAN), including the Internet, providing data communication services.

The system 100 may include a wearable computing device 140. As used herein, a “wearable device” is a portable computing device including a structure so as to be wearable on a person's body (e.g., as a watch or bracelet, as a pendant, etc.) that includes a memory, a processor, a display, and one or more input mechanisms, such as a touchscreen, buttons, etc., as well as hardware and software for wireless communications such as described herein. A wearable device 140 typically will be of a size and shape to be fitted to or worn on a person's body, e.g., a watch-like structure including bracelet straps, etc., and as such typically will have a smaller display than a user device 150, e.g., ⅓ or ¼ of the area. A device that is carried, e.g., in a user's hand, bag, pocket, etc., but not worn, such as so-called smartphone or tablet, is not a wearable device in the context of this disclosure. For example, the wearable device 140 may be a watch, a smart watch, a vibrating apparatus, etc. that includes capabilities for wireless communications using IEEE 802.11, Bluetooth®, BLE and/or cellular communications protocols. Further, the wearable device 140 may use such communications capabilities to communicate via the network 125 and also directly with a vehicle computer 105, e.g., using Bluetooth® or BLE. The wearable device 140 includes a wearable device processor 145.

The wearable device 140 can operate in a power-saving mode. In the power-saving mode (e.g., a sleep mode, a standby mode, etc.), the wearable device processor 145 can reduce a brightness of the wearable device display 170 and reduce the computations performed, thus reducing the power used by the wearable device 140. The wearable device processor 145 can, upon determining to leave the power-saving mode, actuate an active mode for the wearable device 140. In the active mode, the wearable device processor 145 performs calculations and actuates components of the wearable device 140 according to predetermined settings. The wearable device processor 145 can actuate the active mode upon detecting the event and determining that the wearable device 140 is in the power-saving mode.

The system 100 may include a user device 150. As used herein, a “user device” is a portable, non-wearable computing device that includes a memory, a processor, a display, and one or more input mechanisms, such as a touchscreen, buttons, etc., as well as hardware and software for wireless communications such as described herein. That the user device 150 is “non-wearable” means that it is not provided with any structure to be worn on a person's body; for example, a smart phone user device 150 is not of a size or shape to be fitted to a person's body and typically must be carried in a pocket or handbag, and could be worn on a person's body only if it were fitted with a special case, e.g., having an attachment to loop through a person's belt, and hence the smart phone user device 150 is non-wearable. Accordingly, the user device 150 may be any one of a variety of computing devices including a processor and a memory, e.g., a smartphone, a tablet, a personal digital assistant, etc. the user device 150 may use the network 125 to communicate with the vehicle computer 105 and the wearable device 140. For example, the user device 150 and wearable device 140 can be communicatively coupled to each other and/or to the vehicle computer 105 with wireless technologies such as described above. Alternatively or additionally, the wearable device 140 can be a slave device wirelessly connected to user device 150 where user device 150 performs the primary interface to the network 125 and the vehicle 101. Furthermore the wearable device 140, with or without a supporting user device 150, can communicate directly with one or both of the network 125 and the vehicle 101 (e.g. Bluetooth® Low Energy, WiFi, NFC). The user device 150 includes a user device processor 155.

The wearable device processor 145 and the user device processor 155 can instruct the computing device 105 to actuate the components 120. A user can provide an input, e.g., touching, to select an icon on a wearable device 140 display. Based on the user input, the wearable device processor 145 can send a notification to the user device processor 155 and/or the computing device 105 over the network 125 to actuate the components 120 associated with the input.

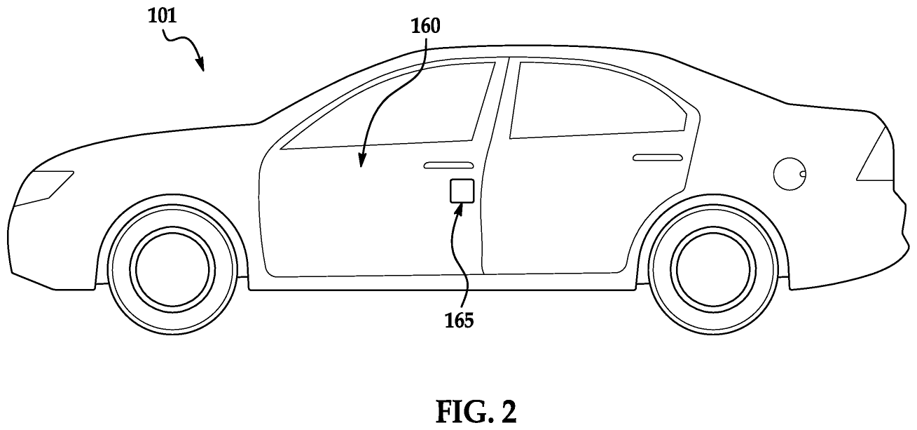

FIG. 2 illustrates an example vehicle 101. The vehicle 101 includes a vehicle door 160. The vehicle door 160 can move from a closed position to an open position. In the closed position, the vehicle door 160 engages a vehicle 101 frame, preventing ingress or egress to a vehicle 101 cabin. In open position, the vehicle door 160 is moved away from the vehicle 101 frame, allowing ingress or egress to the vehicle 101 cabin.

The vehicle door 160 includes a door lock 165. The door lock 165 includes a lock portion and a latch. The lock portion of the door lock 165 prevents movement of the latch. The lock portion thus secures the vehicle door 160 to a vehicle 101 frame, preventing the vehicle door 160 from opening. The door lock 165 can be actuated from an unlocked position to a locked position. In the unlocked position, the vehicle door 160 can move to the opened position, allowing the user to egress or ingress the vehicle 101. When the door is closed and the latch is in its primary position and the door lock 165 is the locked position, the vehicle door 160 is secured against the vehicle 101 frame, preventing the vehicle door 160 from opening. For example, the door lock 165 can include a bolt (not shown) that moves toward the vehicle 101 frame to engage a latch in the locked position, preventing the vehicle door 160 from moving past the vehicle 101 frame. The computing device 105 can be programmed to actuate the door lock 165 when the vehicle door 160 is in either the open position or in the closed position.

The door lock 165 can be controlled by one or more command techniques, e.g., a fob, a keypad, a telematics command, a passive entry/passive start (PEPS) lock switch located on the exterior of the vehicle 101, etc. When the door lock 165 is controlled by a PEPS lock switch, the door lock 165 can be programmed to actuate the lock portion upon satisfying one or more conditions. The conditions can include, e.g., the door 160 being closed, the key fob being within a predetermined distance from the door lock 165, etc.

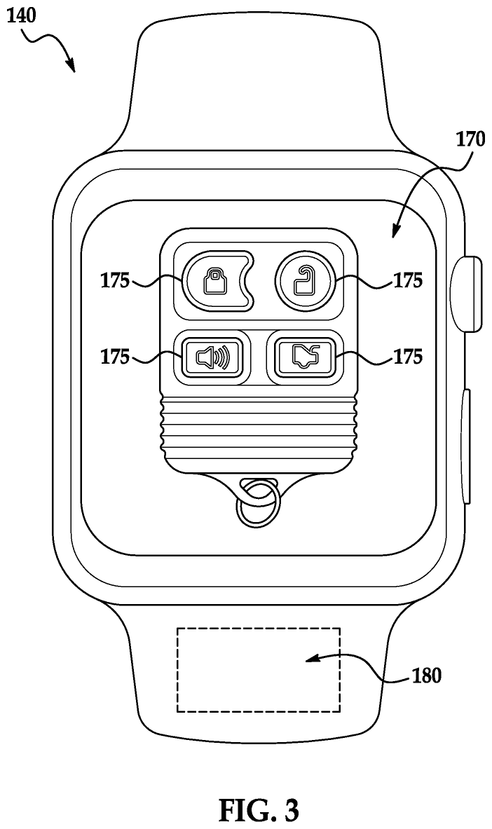

FIG. 3 illustrates an example wearable device 140. The wearable device 140 includes a wearable device display 170. The wearable device display 170 displays images that prompt inputs from the user, e.g., a prompt 175. For example, the wearable device display 170 can display an image of a key fob to prompt inputs from the user to actuate the door lock 165. That is, upon receiving the input from the wearable device display 170 on the prompt 175, the wearable device processor 145 messages the computing device 105 to actuate the door lock 165 to lock or unlock the vehicle door 160.

For example, when the image presented on the wearable device display 170 is a key fob, tapping the prompt 175 indicating a “lock” operation actuates the door lock 165 to the locked position. That is, the wearable device processor 145 can instruct the computing device 105 to actuate the door lock 165 without determining whether the vehicle door 160 is in the open position or in the closed position, whether the latch of the door lock 165 is engaging the vehicle 101 frame, whether the wearable device 140 and/or the user device are currently in the vehicle 101 cabin, etc. When the image presented is a PEPS lock switch, the wearable device processor 145 can be programmed to determine whether the vehicle door 160 is in the closed position and instruct the computing device 105 to actuate the door lock 165 when the vehicle door 160 is in the closed position. Furthermore, the wearable device processor 145 can be programmed to instruct the computing device 105 to actuate the door lock 165 upon receiving a message from, e.g., a sensor 110, indicating that a key fob is detected outside the vehicle 101 cabin. The wearable device processor 145 can be programmed to instruct the computing device 105 to actuate the door lock 165 upon receiving a message from the computing device 105.

The wearable device 140 can include a haptic device 180. The haptic device 180 generates a vibration that is transmitted to the user. The wearable device processor 145 can actuate the haptic device 180 based on receiving an input from the user and/or messages from the computing device 105. For example, when the wearable device processor 145 receives a message indicating that the door lock 165 has been actuated, the wearable device processor 145 can actuate the haptic device 180 to vibrate, indicating to the user that the door lock 165 has been actuated. In another example, when the wearable device processor 145 receives a message indicating that the door lock 165 has failed to engage the vehicle 101 frame, the wearable device processor 145 can actuate the haptic device 180 to vibrate, indicating that the vehicle door 160 has failed to lock. That is, after the wearable device processor 145 instructs the computing device to move the door lock 165 to the locked position, the door lock 165 can remain in the unlocked position. When the door lock 165 remains in the unlocked position after receiving an instruction to move to the locked position, the computing device 105 can determine that the door lock 165 has failed to move to the locked position and thus the vehicle door 160 has failed to lock. The computing device 105 can send a message to the wearable device processor 145 indicating that the door lock 165 is still in the unlocked position after receiving the instruction to move to the locked position. Upon receiving this message, the wearable device processor 145 can actuate the haptic device. The haptic device 180 is shown in FIG. 3 disposed in a wrist band of the wearable device 140, and/or the haptic device 180 can be located in another location in the wearable device 140, e.g., behind the display 170. Additionally or alternatively, the user device 150 can include a haptic device 180 that can be instructed to vibrate by, e.g., the user device processor 155, the wearable device processor 145, and/or the computing device 105.

The wearable device processor 145 and/or the user device processor 155 can be programmed to determine that the user is about to leave the vehicle 101. The wearable device processor 145 and/or the user device processor 155 can be programmed to identify one or more events that indicate that the user is about to leave the vehicle 101. As used herein, an “event” is a vehicle component 120 actuation that the wearable device processor 145 and/or the user device processor 155 is programmed to recognize. That is, the computing device 105 can send data 115 to the wearable device processor 145 and/or the user device processor 155 and the wearable device processor 145 and/or the user device processor 155 can, based on the data, identify the event. Events can include, e.g., a vehicle 101 propulsion deactivating, a gear selector being moved to a parked position, a seat belt buckle disengaging from a seat belt tongue and moving to an unlocked position, a windshield wiper deactivating, the vehicle door 160 opening, etc. The wearable device processor 145 and/or the user device processor 155 can instruct the computing device 105 to actuate the sensors 110 to collect data 115 to detect the events.

Upon detecting the event, the wearable device processor 145 can present the user with one or more prompts 175 on the wearable device display 170 to actuate the door lock 165. For example, as shown in FIG. 3, the wearable device processor 145 can display one or more icons as prompts 175. When the user provides input to select one of the icons, the wearable device processor 145 identifies an icon that received the input and instructs the computing device 105 to actuate the door lock 165 according to the selected icon. The wearable device processor 145 can instruct the computing device 105 to actuate the door lock 165 when the vehicle door 160 is in either the open position or the closed position. Thus, the wearable device processor 145 can present the prompts 175 upon detection of the event regardless of whether the vehicle door 160 is in the open position or in the closed position. For example, if the user selects the icon indicating the “lock” function, the wearable device processor 145 can instruct the computing device 105 to actuate the door lock 165 to the locked position. The wearable device processor 145 can, alternatively or additionally, send a message, e.g., via the network 125, to the user device processor 155 to instruct the computing device 105 to actuate the door lock 165.

Additionally or alternatively, the wearable device processor 145 can display one or more prompts 175 on the wearable device display 170 associated with a conditional locking event, e.g., a PEPS lock switch. In a conditional lock event, the computing device 105 can require that one or more conditions be determined to be satisfied before actuating the door lock 165. Example conditions include, e.g., the vehicle door 160 is in the closed position, the latch of the door lock 165 is engaged with the vehicle 101 frame, the wearable device 140 and/or user device 150 are located outside the vehicle 101 cabin, etc. In another example, when the image of a PEPS lock switch is presented on the display of user device 150, the computing device 105 can be programmed to actuate the door lock 165 upon determining that the vehicle door 160 is in the closed position, the latch of the door lock 165 is engaged with the vehicle 10 frame, the user device 150 is in the vehicle 101 cabin, and the wearable device 140 is outside the vehicle 101 cabin. The computing device 105 can display a cabin exterior keypad code to the wearable device display 170 to disengage the door lock 165 when the PEPS lock switch identifies the user device 150 as a key, e.g., when the wearable device 140 is a slave to the user device 150.

The wearable device processor 145 can display the prompts 175 on the wearable device display 170 until the wearable device processor 145 determines that the prompts 175 should be removed. For example, the user may actuate the door lock 165 with a separate key fob, and the computing device 105 can send a message, e.g., via Bluetooth® communications or the like, to the wearable device processor 145 indicating that the door lock 165 has been actuated. Upon receiving the message, the wearable device processor 145 can remove the prompts 175 from the wearable device display 170. In another example, the wearable device processor 145 can determine a distance between the wearable device 140 and the vehicle door 160 based on location sensors 110 in the vehicle door 160 and the wearable device 140. When the distance between the wearable device 140 and the vehicle door 160 exceeds a distance threshold, e.g., five feet, ten feet, etc., the wearable device processor 145 can remove the prompts 175 from the wearable device display 170.

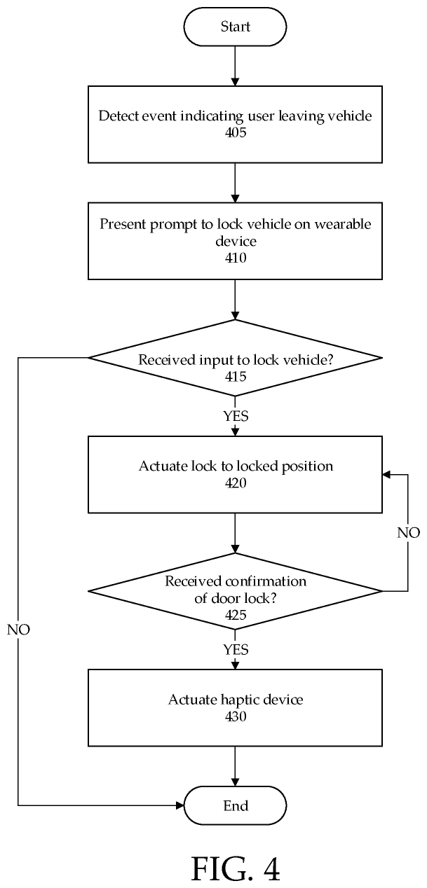

FIG. 4 illustrates an example process 400 for locking a vehicle door 160 with a wearable device 140. The process 400 begins in a block 405, in which the wearable device processor 145 detects an event indicating that a user is about to leave the vehicle 101. As described above, the wearable device processor 145 can communicate with the computing device 105 to use data 115 from the sensors 110 to determine whether an event indicating that the user is about to leave the vehicle 101 has occurred. For example, the event can be a deactivation of the vehicle 101 propulsion. In another example, the event can be an uncoupling of a seat belt buckle after a deactivation of the vehicle 101 propulsion. In another example, the event can be moving the gear selector to park, deactivation of the vehicle 101 windshield wiper, deactivation of the vehicle 101 propulsion, uncoupling of a seat belt buckle, a detection of the driver-side vehicle door 160 in the open position, a detection that the door lock 165 is in the unlocked position, etc.

Next, in a block 410, the wearable device processor 145 presents a prompt 175 on the wearable device display 170 to lock the vehicle door 160. The prompt 175 can be, e.g., an icon displayed on the wearable device display 170. The wearable device processor 145 can display more than one prompt 175, including prompts 175 to unlock the vehicle door 160, to start the vehicle 101 propulsion remotely, etc. If the wearable device 140 is in a power-saving mode, the wearable device processor 145 actuates an active mode prior to presenting the prompt 175.

Next, in a block 415, the wearable device processor 145 determines whether the user has provided an input to the wearable device display 170 to lock the vehicle 101. For example, the wearable device processor 145 can detect that the user has touched one of the prompts 175 on the wearable device display 170. If the wearable device processor 145 determines that the user has provided input to lock the vehicle 101, the process 400 continues in a block 420. Otherwise, the process 400 ends.

In the block 420, the wearable device processor 145 instructs the computing device 105 to actuate the door lock 165 to the locked position. The computing device 105 then instructs the door lock 165 to move to the locked position. As described above, in the locked position, the door lock 165 prevents the latch from being disengaged from the vehicle 101 frame, thus securing the vehicle door 160 in the closed position to the vehicle 101 frame.

Next, in a block 425, the wearable device processor 145 determines whether the vehicle door lock 165 is in the locked position and the vehicle door 160 is in the closed position. Upon moving the vehicle door lock 165 to the locked position, the computing device 105 sends a message to the wearable device processor 145. Upon receipt of the message, the wearable device processor 145 determines that the vehicle door lock 165 is in the locked position and the vehicle door 160 is in the closed position. If the wearable device processor 145 determines that the vehicle door lock 165 is in the locked position and the vehicle door 160 is in the closed position, the process 400 continues in a block 430. Otherwise, the process 400 returns to the block 420 to actuate the vehicle door lock 165. Alternatively or additionally, when the wearable device processor 145 and/or the user device processor 155 has not received a message from the computing device 105 within a time threshold, (e.g., 5 seconds), the wearable device processor 145 and/or the user device processor 155 can actuate a haptic device 180 to vibrate and/or flash a light, providing feedback to the user that the vehicle door 160 is not locked. The wearable device processor 145 can, additionally or alternatively, present a message on the wearable device display 170 indicating that the vehicle door 160 is not in the locked position.

In the block 430, the wearable device processor 145 actuates a haptic device 180 in the wearable device 140. The haptic device 180 can vibrate and/or flash a light, providing feedback to the user that the vehicle door 160 is locked. The haptic device 180 can be actuated in with a pattern of vibrations and/or lights that differs from a pattern used when the wearable device processor 145 indicates that the vehicle door 160 is not locked. Thus, the user can identify whether the vehicle door 160 is locked or is not locked based on the pattern of vibrations and/or lights. The wearable device processor 145 can, additionally or alternatively, present a message on the wearable device display 170 indicating that the vehicle door 160 is in the locked position. Following the block 430, the process 400 ends.

As used herein, the adverb “substantially” modifying an adjective means that a shape, structure, measurement, value, calculation, etc. may deviate from an exact described geometry, distance, measurement, value, calculation, etc., because of imperfections in materials, machining, manufacturing, sensor measurements, computations, processing time, communications time, etc.

Computing devices 105 generally each include instructions executable by one or more computing devices such as those identified above, and for carrying out blocks or steps of processes described above. Computer executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in the computing device 105 is generally a collection of data stored on a computer readable medium, such as a storage medium, a random access memory, etc.

A computer readable medium includes any medium that participates in providing data (e.g., instructions), which may be read by a computer. Such a medium may take many forms, including, but not limited to, nonvolatile media, volatile media, etc. Nonvolatile media include, for example, optical or magnetic disks and other persistent memory. Volatile media include dynamic random access memory (DRAM), which typically constitutes a main memory. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. For example, in the process 400, one or more of the steps could be omitted, or the steps could be executed in a different order than shown in FIG. 4. In other words, the descriptions of systems and/or processes herein are provided for the purpose of illustrating certain embodiments, and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a nonprovisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

The article “a” modifying a noun should be understood as meaning one or more unless stated otherwise, or context requires otherwise. The phrase “based on” encompasses being partly or entirely based on.

1. A system, comprising a computer programmed to:
present a prompt on a display of a wearable device upon detecting an event indicating a user leaving a vehicle;
receive an input responding to the prompt; and
instruct a vehicle door lock to move to a locked position upon receipt of the input.

2. The system of claim 1, wherein the event is one of a seat belt buckle moving to an unlocked position, moving a gear selector to a parked position, a deactivation of a vehicle propulsion, a deactivation of a windshield wiper, an opening of a vehicle door, and a detection that the vehicle door lock is in an unlocked position.

3. The system of claim 1, wherein the computer is further programmed to remove the prompt from the display upon one or both of receipt of a message indicating that the vehicle door lock is in the locked position and determining that the wearable device is farther than a predetermined distance threshold from the vehicle.

4. The system of claim 1, wherein the computer is further programmed to instruct the vehicle door lock based on a location of a user device.

5. The system of claim 1, wherein the computer is further programmed to actuate a haptic device in the wearable device upon receipt of a message indicating that the vehicle door lock is in the locked position.

6. The system of claim 1, wherein the computer is further programmed to actuate a haptic device in the wearable device upon receipt of a message indicating that the vehicle door lock is in the unlocked position after instructing the vehicle door lock to move to the locked position.

7. The system of claim 1, wherein the computer is further programmed to instruct the vehicle door lock when a vehicle door is in a closed position.

8. The system of claim 1, wherein the computer is further programmed to instruct the vehicle door lock when a vehicle door is in an open position.

9. The system of claim 1, wherein the computer is further programmed to instruct the vehicle door lock when the wearable device is within a distance threshold of a vehicle door.

10. The system of claim 1, wherein the computer is further programmed to determine whether the wearable device is in a power-saving mode and to actuate an active mode upon determining that the wearable device is in the power-saving mode.

11. A method, comprising:
presenting a prompt on a display of a wearable device upon detecting an event indicating a user leaving a vehicle;
receiving an input responding to the prompt; and
instructing a vehicle door lock to move to a locked position upon receipt of the input.

12. The method of claim 11, wherein the event is one of a seat belt buckle moving to an unlocked position, moving a gear selector to a parked position, a deactivation of a vehicle propulsion, a deactivation of a windshield wiper, an opening of a vehicle door, and a detection that the vehicle door lock is in an unlocked position.

13. The method of claim 11, further comprising removing the prompt from the display upon one or both of receipt of a message indicating that the vehicle door lock is in the locked position and determining that the wearable device is farther than a predetermined distance threshold from the vehicle.

14. The method of claim 11, further comprising instructing the vehicle door lock based on a location of a user device.

15. The method of claim 11, further comprising actuating a haptic device in the wearable device upon receipt of a message indicating that the vehicle door lock is in the locked position.

16. The method of claim 11, further comprising actuating a haptic device in the wearable device upon receipt of a message indicating that the vehicle door lock is in the unlocked position after instructing the vehicle door lock to move to the locked position.

17. The method of claim 11, further comprising instructing the vehicle door lock when a vehicle door is in a closed position.

18. The method of claim 11, further comprising instructing the vehicle door lock when a vehicle door is in an open position.

19. The method of claim 11, further comprising instructing the vehicle door lock when the wearable device is within a distance threshold of a vehicle door.

20. The method of claim 11, further comprising determining whether the wearable device is in a power-saving mode and actuating an active mode upon determining that the wearable device is in the power-saving mode.
